(19) United States
(12) Patent Application Publication
(10) Pub. No.: US 2013/0238396 A1
(43) Pub. Date: Sep. 12, 2013

(54) METHOD, SYSTEM AND APPARATUS FOR DESIGNING ASSESSMENT REPORT

(71) Applicant: Jukka SAPPINEN, Espoo (FI)

(72) Inventor: Jukka SAPPINEN, Espoo (FI)

(21) Appl. No.: 13/413,388

(22) Filed: Mar. 6, 2012

(51) Int. Cl. G06Q 30/02

(52) U.S. Cl. 705/7.32

(57) ABSTRACT

A method comprises maintaining, in a database, assessment data from a plurality of assessment tools; maintaining report elements for a report template; selecting, by a user, at least one report element for the report template; and determining a location for the selected report element in the report template. The method further comprises processing the assessment data for the selected report elements; and providing the assessment report using the report template and the processed assessment data.

### TECHNICAL FIELD

The present disclosure generally relates to dynamic assessment system's reporting. The present disclosure relates more particularly, though not exclusively, to designing the assessment report for the assessment results.

Technology has been developed to help in providing decision makers with information relating to human behavior, values, attitudes, motivators and other areas influencing human personality and behavior. Typical users of such information would be anyone needing to understand any aspect of human personality or factors influencing it in order to better understand the behavior of the individual, whether the individual is the person him/herself or any other person.

Information is usually collected by asking the person him/herself to complete a questionnaire (often called self-assessment questionnaire) or asking other people to complete it assessing this person (often called 360 assessment questionnaire). Also other methods for collecting the data exist. The questionnaire can be in paper format, shown on stand-alone or network computer or presented via internet.

Typically, the answers are processed via software using specifically designed algorithms that process the original answers to format more usable for the receiver of the information. The outcome of the process (often called assessment report) can be processed manually, by the computer or by a central server connected to the internet browser. The results can be processed immediately, after all respondents have completed their questionnaires, at a pre-defined time or at any time defined by a user who has usage rights to decide and administer this process. The results can be processed of one person and/or several persons in the same report. The results can be shown on the computer screen or internet browser or they can be emailed as an attachment or download link to the respondent and/or any other person. The process of showing and sending the results can be automated or conducted manually at any time.

Current assessment providers sell assessments and reports that they have designed. Such assessment reports have more or less fixed content and are not linked with other material used for the same purpose as the assessment report. The reports are about one person or one team and leave out the comparison of the information to other information outside the content of the report. Additionally, every report is based on one assessment tool, and the users need to manually compare results of different assessment tools.

There is a need for the users (human resources, management, consultants and all individuals) to be able to design content and format of the assessment report more freely from the beginning.

The typical areas of application for this information vary, but may contain at least one of the following: recruitment, career planning, training need analysis, job design, skills development, market research, organizational climate survey, customer satisfaction survey, receiving/providing feedback, coaching, marital counseling and interpersonal skills training. In business organizations, the users of the information are typically human resources, management at different levels, training department, external consultants, teams and the individuals.

### BACKGROUND ART

A variety of assessments provided for client organization processes is increasing. At the same time the utilization of the assessment reports becomes more difficult.

The assessment report content is often being designed by the provider of the report whereas the user of the report may not have possibilities to influence the content of the report. The assessment report carries the outlook (and the brand) of the provider of the report, and the user may not be able to combine results of all assessments they have processed in the past in a flexible way. Each assessment project may be required to be dealt as an independent process.

The content of the report is typically designed by the external provider of the assessment and the user needs to take the report as such. Some assessment instruments provide possibilities to influence the content of the report to some extent, like changing the page order or selecting from pre-defined entities which will be included in the report. However, it is not possible to create new elements to the report and design the content of the report from the very beginning. Current tools, systems, interfaces and methods provide only limited capabilities for users to easily access the assessment data and manage the data in a timely manner (for example what information they exactly want, where they want the information to be, when they want the information, how they want the information to be delivered to them, why they want the information, who they want to be included in the information).

Currently popular method for selecting an assessment provider is based on a user trying to find an assessment report provider whose assessment report matches best to an intended application of the user. The user may search among the available report providers for the available report best matching with their needs. Furthermore, the user may design a questionnaire and link the report between the process and other material. The user may create material that helps navigating between the report and the application process. This requires extra work and never results in perfect integration. The report carries the brand and style of the report provider, leaving it as external material to the other material used. User can also reproduce the information but needs to produce additional charts (for example by using an external chart tool) to compare the results of different assessment projects.

The aspects of the disclosed embodiments address drawbacks of existing solutions and technologies, to provide new, enhanced solutions and techniques and/or to provide new technical alternatives.

### SUMMARY

According to a first aspect of the disclosed embodiments there is provided a method comprising:

maintaining, in a database, assessment data from a plurality of assessment tools;

maintaining report elements for a report template;

selecting, by a user, at least one report element for the report template;

determining a location for the selected report element in the report template;

processing the assessment data for the selected report elements; and

providing the assessment report using the report template and the processed assessment data.

The report elements may be static elements comprising static data collected from the database or defined by the user.

The report elements may be dynamic elements comprising dynamic data collected from the database based on the assessment data.

The assessment data may comprise at least one of the following:
data collected for a particular assessment report; and
data collected for a plurality of assessment reports.

The static data may comprise at least one of the following:
responses by a user;
user data; and
user defined data.

The user data may comprise at least one of the following:
country information;
organization information;
brand information;
project information;
application information; and
time information.

The user defined data may comprise at least one of the following:
heading information;
instructions information;
table of content;
background information;
workbook information; and
image information.

The assessment data may comprise at least one of the following:
responses by a respondent;
responses by at least one user;
respondent data;
user data; and
assessment external data.

The assessment external data may comprise comparable assessment data received from external sources. Such data may comprise, for example, at least one of the following:
data from an external database, such as SAP;
data from an external assessment database; and
comparison data from a theoretical model.

The responses by the respondent may comprise at least one of the following:
data collected from a particular respondent; and
data collected from a plurality of respondents.

The method may further comprise:

storing a plurality of users, assigned with at least one nonhierarchical dependency, for defining a dynamic user structure.

The method may further comprise:

storing at least one user, from the plurality of users, as an owner of the report template.

The method may further comprise:

defining, by the owner, user rights for the report template for other users, the user rights comprising at least one of the following:
access rights to the report template;
edit rights to the report template; and
clone rights to the report template for creating an independent copy of the report template.

The stored owner may allow users with user specific rights to the report template.

In an embodiment, the method further comprises:

determining a target for the assessment report from at least one of the following:
a single person;
multiple persons;
a single organization; and
multiple organizations;

selecting a pre-defined report template based on the determined target; and

providing the assessment report using, at least partly, the pre-defined report template and the processed assessment data.

In an embodiment, the method further comprises:

defining the report elements, the report elements comprising at least one of the following:
a behavioral competence;
a competence template;
a text element;
a workbook element;
an image element;
a benchmark element;
an empty element;
a graphics element; and
a user designed element.

The database may comprise at least one of a global database and a personal database. The global database may be accessible to registered users of a service system. The personal database may be accessible to users having access rights based on nonhierarchical dependencies.

In an embodiment, the method further comprises:

processing the assessment data for the selected report elements by at least one of the following server apparatuses;
a service system server comprising the database;
an external server; and
a user apparatus.

According to a second aspect of the disclosed embodiments there is provided a server apparatus comprising:

a communication unit configured to provide access to a user apparatus;

a processor;

a memory including computer program code;

the memory and the computer program code configured to, with the processor, cause the server apparatus to:
maintain, in a database, assessment data from a plurality of assessment tools;
maintain report elements for a report template;
select, by a user, at least one report element for the report template;
determine a location for the selected report element in the report template;
process the assessment data for the selected report elements; and
provide the assessment report using the report template and the processed assessment data.

According to a third aspect of the disclosed embodiments there is provided a computer program embodied on a computer readable medium comprising computer executable program code which, when executed by at least one processor of an apparatus, causes the apparatus to:

maintain, in a database, assessment data from a plurality of assessment tools;

maintain report elements for a report template;

select, by a user, at least one report element for the report template;

determine a location for the selected report element in the report template;

process the assessment data for the selected report elements; and

provide the assessment report using the report template and the processed assessment data.

According to a fourth aspect of the disclosed embodiments there is provided a memory medium or computer readable medium carrying the computer program of the third example aspect.

According to a fifth aspect of the disclosed embodiments there is provided a user apparatus comprising:

a communication unit configured to provide access to a server apparatus;

a processor;

a memory including computer program code;

the memory and the computer program code configured to, with the processor, cause the user apparatus to:
access, a database of the server apparatus, maintaining assessment data from a plurality of assessment tools;
access report elements for a report template;
select, by a user, at least one report element for the report template;
determine a location for the selected report element in the report template;
trigger processing of the assessment data for the selected report elements; and
receive, from the server apparatus, the assessment report using the report template and the processed assessment data.

Any foregoing memory medium may comprise a digital data storage such as a data disc or diskette, optical storage, magnetic storage, holographic storage, opto-magnetic storage, phase-change memory, resistive random access memory, magnetic random access memory, solid-electrolyte memory, ferroelectric random access memory, organic memory or polymer memory.

The memory medium may be formed into a device without other substantial functions than storing memory or it may be formed as part of a device with other functions, including but not limited to a memory of a computer, a chip set, and a sub assembly of an electronic device.

Different non-binding example aspects and embodiments of the present disclosure have been illustrated in the foregoing. The above embodiments are used merely to explain selected aspects or steps that may be utilized in implementations of the aspects of the disclosed embodiments. Some embodiments may be presented only with reference to certain aspects of the present disclosure. It should be appreciated that corresponding embodiments may apply to other aspects as well.

### BRIEF DESCRIPTION OF THE DRAWINGS

The aspects of the disclosed embodiments will be described, by way of example only, with reference to the accompanying drawings, in which:

FIG. 1 shows a schematic picture of an assessment system having data flows between elements in a system according to an example embodiment of the present disclosure;

FIG. 2 shows a schematic diagram of an assessment service system providing assessment data objects according to an example embodiment of the present disclosure;

FIG. 3 presents an example block diagram of an apparatus in which various embodiments of the present disclosure may be applied;

FIG. 4 shows a schematic diagram of a report designer view according to an example embodiment of the present disclosure;

FIG. 5 shows a schematic diagram of a report elements view according to an example embodiment of the present disclosure; and

FIG. 6 shows a flow chart of exemplary method steps for providing a dynamic assessment report designer according to an example embodiment of the present disclosure.

### DETAILED DESCRIPTION

In the following description, like numbers denote like elements. The systems and techniques described here relate to presenting predictive data objects based on contextual profile information.

In an embodiment, the users are allowed to define what type of information the report contains and how it is constructed. The designer application needs to be easy to use, self-explanatory and support the creativity of the user.

In an embodiment, the users are allowed to add information that is not directly related to the assessment information or does not necessarily come from the provider of the assessment report. Such information could comprise, for example, instructions how to use the information for a particular purpose, background information to the reader, workbook fields, support material for training, tables and images.

In an embodiment, the users are allowed to design the content for single person's information to be included in the report or multiple persons included in the same report. The report may support comparing the individuals against each other, selecting any of the individuals and comparing this person against the other individuals and/or looking at each individual separately. This design may apply not only to the text provided but also to tables, graphics and images.

In an embodiment, the users are allowed to automatically compare the information against other information the user has (or other users have) in the system database. Such comparison could be against other applicants or previous applicants (when hiring people), current or previous employees of the organization, industry, organization level or country benchmarks, or any set criteria.

In an embodiment, the users are allowed to include information from different assessment tools in the same assessment report. The person may have completed self-assessments of different kind (behavioral or reasoning skills, for example) and have different 360 assessments completed of him/her. The person may also be a part of an organization that has surveys conducted on organizational level. Combining all such information to the same report that proceeds logically and supports finding the key information, benefits the user greatly.

In an embodiment, the user may select for the report template elements from different assessment tools, and position the elements at any place and at any order in the report view.

In an embodiment, an assessment report may be produced using at least one report template.

In an embodiment, the users are allowed to compare the information of the same person from the same assessment instrument. It may well be useful for a user to see how the results of a person have changed in time and have all that in one report, instead of having to manually compare different reports.

In an embodiment, the users are allowed to design several different reports of the same person to be used in different situations or by different people, and have the system to send the correct information at correct time to correct recipient. One example could be a report of a person to be coached by a professional business coach. A different report would be sent to the coach (including perhaps instructions how to approach the person) and the coachee (including, for example, workbook fields to support understanding the information).

In an embodiment, the users are allowed to design the assessment report independently. Currently, even in the case of having acquired the same information from the same assessment provider, the user has to carry additional costs for achieving all the above.

According to an example embodiment of the invention, information relating to the intended application is integrated to the assessment report. For example, the assessment report is made as a workbook in a training session by the system, instead of having a separate workbook that refers to different parts of the assessment report. In an embodiment, the assessment report is integrated in the company's interview process (when recruiting new people) in a way that it would actually work as a walk-through manual for the interviewer. This would help tremendously especially less experienced interviewers who would have a ready designed interview manual that is tailored for this particular applicant.

Designing of the assessment reports may also have the same look as all their user materials carrying their own brand. Furthermore, users of the assessment tools may have more flexibility in comparing results against each other and against other instruments, against company/national/international norms and benchmarks. In an embodiment, a system of assessment tools provides the user with an online solution enabling on-screen interactive comparison of results against any set benchmark criteria. Such solutions change the assessment solutions from “assessment” to “management” system.

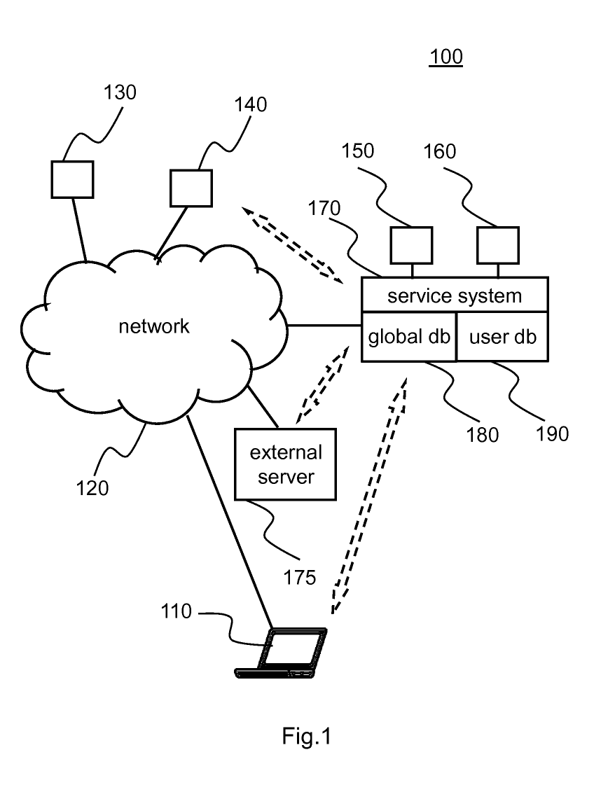

FIG. 1 shows a schematic picture of an assessment system having data flows between elements in a system according to an example embodiment of the present disclosure. The assessment system 100 provides assessment data flows between elements in the system 100. The system 100 includes an apparatus 110, shown as a portable computer for communicating with a user, but could take any appropriate form, such as a cellular telephone handset, a tablet, a personal digital assistant, a personal computer, or a voice-driven communication device.

The apparatus 110 may obtain the information the user needs through network 120 that may be a single network or combination of networks. The apparatus 110 may also generate information. An assessment service system 170 may also communicate with the network 120 to receive assessment data object requests from the apparatus 110 and locate information to return to the apparatus 110. The assessment service system 170 may be of any applicable form.

Among other components included in the assessment service system 170 there may be a global database 180, a user database 190, an index database 150 and a cached information database 160. The global database 180 contains assessment data that is available to all users of the assessment service system 100, for example public assessment questionnaires, public report formats, public responses to assessment questionnaires and benchmark information. The user database 190 contains assessment data that is available only to the dedicated user of the assessment service system 100, for example private assessment questionnaires, private report formats, private responses to assessment questionnaires, user profile information and private benchmark information. The index database 150 contains data that represent searchable information available to the assessment service system 170. For example, the assessment service system 170 may scan the internet, intranets or various databases for content such as web sites, service providers, external indexes or workgroup discussions, may extract key words and other objects from the content, and may organize the information in a manner that permits ready searching and retrieval. The index database 150 may also generate other information from the content, such as indicators of how certain web sites link to other web sites, and other related metadata. Assessment data may also be transferred between the databases 180, 190. For example, a user having cloning rights may clone an item from the global database 180 to the user database 190. Alternatively, the user having cloning rights may clone an item from a first user database 190 to a second user database 190.

In an example embodiment of the present disclosure, the cached information database 160 contains copies or substantial copies of content that the service system 170 locates. For example, the cached information database 160 may contain assessment questionnaires, report formats, benchmark information, user profiles, web pages or portions of web pages, for example only textual, only non-video content, only images or only specific metadata. In this manner, a user who accesses system 170 may request the cached information rather than making direct connection with the content provider, such as when the content provider is inaccessible, has changed the content since it was cached, or when the connection to the content provided is substantially slower than that to the assessment service system 170. Service system 170 may also be used to provide partial or subsets of information or combinations of information that may be preferable, in some cases, to full web content directly from source systems.

The assessment system 100 may also include other nodes 130, 140 connected to the network 120. These nodes 130, 140 could include any sort of device or devices capable of communicating with or over the network 120. For example, node 130 could be a user apparatus responding to the assessment questionnaire defined by the user of device 110. Node 130 may also be a web server that is capable of delivering content in response to requests by users, such as a user of device 110, or deliver content automatically based on a variety of attributes and variables. As another example, node 140 could be an external service provider that may be accessed by the device 110 or the assessment service system 170.

In an embodiment, the assessment system may also include an external server 175. The external server 175 may comprise any element of the service system server 170 or all elements of the service system server 170. The external server 175 may provide a part of the service provided by the service system server 170, for example processing of the assessment data, processing the report elements or processing the report template. All the elements of the service system server 170 may be included also in the external server 175 or only certain elements being selected.

In an embodiment, the user apparatus 110 may comprise a device operated by a user or a server apparatus operated by an external service system.

Dashed arrows in FIG. 1 show an exemplary flow of information relating to the provision of a response to a request from apparatus 110, 130, 140 along with the provision of assessment data object information to apparatus 110, 130, 140. Requests can be initiated by either apparatus 110 or by assessment service system 170. Although the request passes through network 120 (and other components that are not pictured), it is directed at service system 170. Service system 170 then receives the assessment request and applies it to an assessment process, such as by parsing the request, locating available content in databases 150, 160, 180, 190 that contains available responses for the request. The service system 170 may then transmit assessment requests to respondents 130, 140 relating to assessment questionnaire objects without available responses, receive responses from the respondents 130, 140, organize the assessment information to a report in the assessment service system 170, as defined by the requesting user 110, and transmit the report, or indication of it, to designated users 110 through network 120 as a service result. For example, the returned information may also be transcoded to appropriate format for processing in the apparatus 110, such as HTML code, XML messages, WAP code, java applets, JavaScript object notations (JSONs), xhtml, plain text, voiceXML, VoxML, VXML or such.

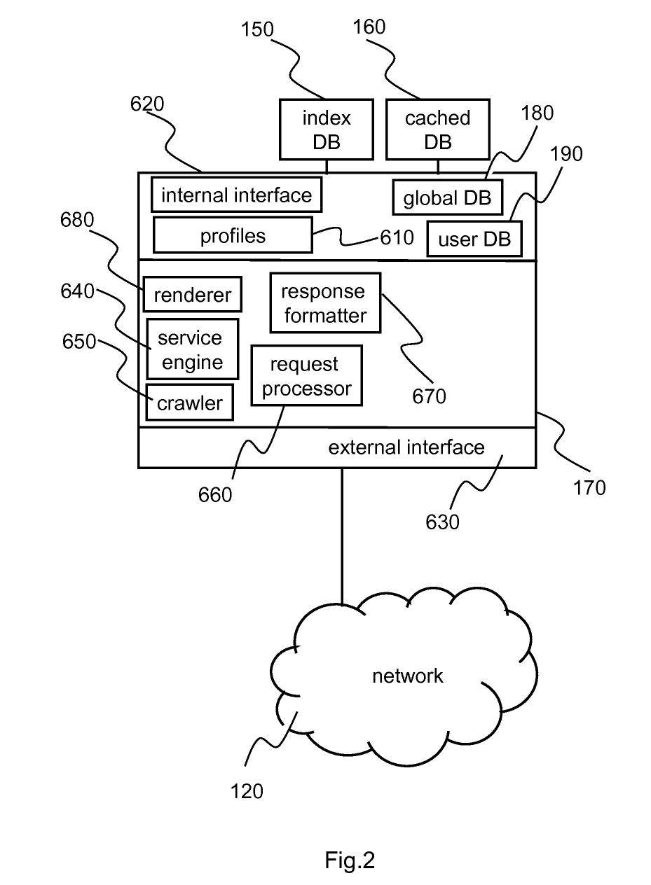

FIG. 2 shows a schematic diagram of an assessment service system 170 providing assessment data objects according to an example embodiment of the present disclosure. Service system 170 may receive and/or request for assessments, generate assessment questionnaire responses to the requests, and generate assessment questionnaire objects based on certain criteria, for example different profile information, algorithms and such. Service system 170 is connected to a network 120, such as the internet, to be able to communicate with users who may be interested in accessing the services provided by assessment service system 170. The assessment service system 170 may be broken into multiple separate systems to allow for scalability, and may be connected to network 120 in any of a variety of ways, as is commonly known.

The service system 170 may include a global database 180 and a user database 190. Furthermore the service system 170 may also include an index database 150 and a cached information database 160. These databases 150, 160, 180, 190 may be connected to service system 170, for example, by a high bandwidth LAN or WAN, or could also be connected to the search system 170 through network 120. The databases may also be located in the same location as the assessment system 170 or split up so that they are located in multiple locations, for example in an external server 175 or in the user apparatus 110 of FIG. 1.

Search system 170 may communicate through an internal interface 620 and an external interface 630, which are shown as distinct interfaces, but may be partially or fully combined, or may be represented by additional interfaces. For example, internal interface 620 may comprise interface devices for a high speed, high bandwidth network such as SONET, Infiniband, or Ethernet network cards, or any appropriate communication hardware operating under an appropriate protocol, so that assessment service system 170 can respond to a large number of distinct assessment requests simultaneously. External interface 630 may comprise interface devices for communicating with network 120, such as ethernet network interface cards (NICs) or other communications devices. The precise design of the service system 170 could take any appropriate form.

Within the service system 170, a service engine 640 operates to produce assessment service results in response to assessment service requests from users, employing information stored in databases 150, 160, 180, 190. The information in index database 150 may be gathered by a crawler 650, which may continuously or almost continuously obtain new information from sources connected to network 120. A renderer 680 may be included in the service system 170 for rendering data object related information according to system specific format. Rendering may be done also in the crawler 650, in the service engine 640 or in the external interface 630. Service requests, such as assessment questionnaires, may be received through the external interface 630 and handled by the request processor 660. For example, request processor 660 may parse the requests and reformat them, for example from html/text requests to internally usable search terms/strings. The assessment information generated by the service engine 640 in response to a request may also be converted by response formatter 670 in a manner that allows it to be used by the requesting device, such as in a WAP format, HTML document, XML document or VoiceML result, and then transmitted via external interface 630.

Assessment service information may be retrieved and/or generated by the service engine 640, which may monitor requests from a user, responses to the user or any number of requests and responses not exclusively related to a particular user. To clarify, these requests and responses may be generated by internal or external systems and services. In this manner, the service engine 640 is able to begin working as soon as a request is received or a response is delivered, either from a user of the system, or from other system components or external systems. For example, where an assessment questionnaire request is received by the service system 170, that request may be processed and forwarded to service engine 640. In addition, the service engine 640 may recognize the request, and cause additional formatted requests to be forwarded to the service engine. The service engine 640 may cause the assessment information that results from those requests to be transmitted to the user's apparatus or external services, for example, using response formatter 670.

The service engine 640 may include, for example, assessment rules, algorithms, data and assessment engine. The assessment rules may include parameters that may be selected and changed to manage the manner in which assessment information is gathered. The rules may be specific to particular users (e.g., in a profile of rules for the user, or with pointers for a user to particular parameters to minimize storage space required).

The assessment service system 170 may continually learn from users and it is possible to build a dedicated index, for example a content matching engine, based on the data passing through the system. Such index may be located in the index database 150. It is also possible to use any available public or proprietary index, for example but not limited to, an openly available index on the internet or a corporate database within a corporate intranet.

In one embodiment of the present disclosure the dynamic profile information may contain several types of attributes discussed earlier in this application. Profile information for the users may be located in system storage block 610 of FIG. 2. Profile information may also be located in the user database 190 or in the global database. Profiles 610 may also connect to other users and systems, including both internal and external users and systems. Profiles and filters may be adapted and applied to external systems, partially or wholly, and external profile information and/or filter information may be adapted and applied, either partially or wholly, to internal profiles and filters.

In an example embodiment of the present disclosure, the service system described in FIGS. 1 to 2 may be applied to various purposes, for example enterprise assessment data management, personal assessment data management and remote assessment.

In enterprise data management, the assessment service system may provide any assessment service based on company and/or employee needs, for example recruitment, training need analysis, skills development, market research, organizational climate survey, customer satisfaction survey, receiving/providing feedback, coaching and interpersonal skills training. User profile information may be applied to enterprise usage. There are vast amount of information contained in corporate intranets, corporate database systems and related systems. For example in customer relationship management tools, human resources tools, project management tools, requirements management tools, communications tools, recruitment tools, marketing tools, strategic planning tools, financial tool and additionally in relevant external data sources. However, this information is often under-utilized as companies, and their employees face difficulties in providing and/or discovering and/or sharing the most relevant and beneficial data objects in a timely manner. The ability to increase the efficiency and/or enjoyment of this represents a significant opportunity to increase productivity and competitiveness in enterprises.

In personal data management, the service system may provide assessment service based on personal information needs. Such assessment service may be for example, career planning, training need analysis, skills development, receiving/providing feedback, coaching, marital counselling and interpersonal skills training. User profile information may be applied to personal usage. Individuals increasingly create, store, manipulate, backup and share an increasing amount of data objects across a wide variety of services and apparatuses. These data objects represent a vast potential resource for individuals. However, these are often under-utilized as individuals face difficulties in providing and/or discovering and/or sharing the most relevant and beneficial data objects in a timely manner. The ability to increase the efficiency and/or enjoyment of this represents a significant opportunity to increase personal productivity and satisfaction of individuals.

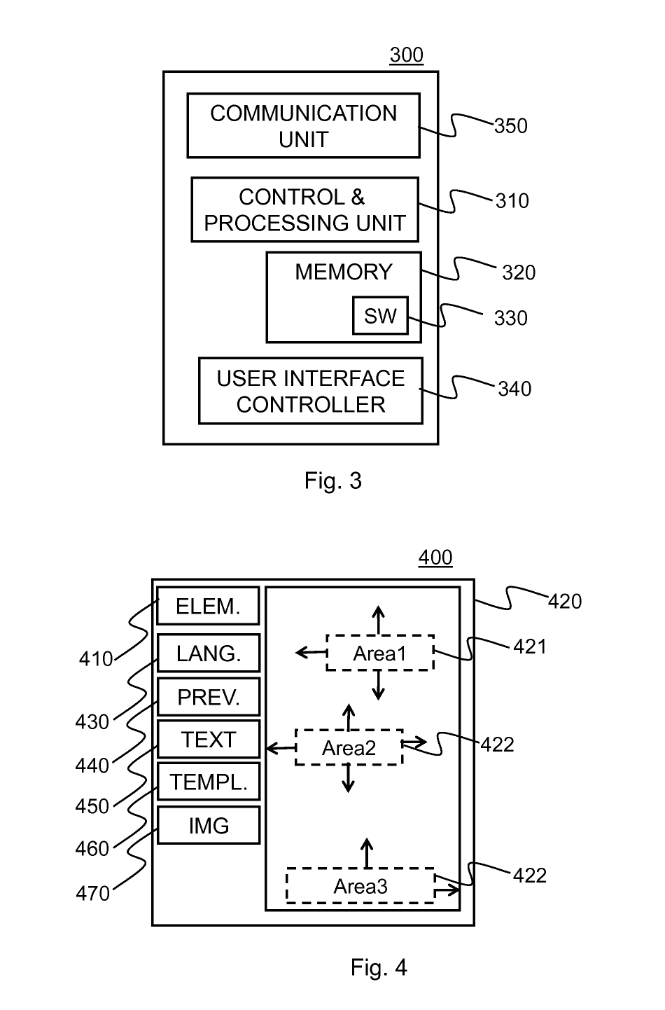

FIG. 3 presents an example block diagram of an apparatus 300 in which various embodiments of the present disclosure may be applied. This may be a user device or apparatus, such as a laptop, a desktop, a mobile terminal or other communication device.

The general structure of the apparatus 300 comprises a communication interface module 350, a processor 310 coupled to the communication interface module 350, and a memory 320 coupled to the processor 310. The apparatus further comprises software 330 stored in the memory 320 and operable to be loaded into and executed in the processor 310. The software 330 may comprise one or more software modules and can be in the form of a computer program product. The apparatus 300 further comprises a user interface controller 340 coupled to the processor 310.

The communication interface module 350 implements at least part of the user data radio discussed in connection with various embodiments of the present disclosure. The communication interface module 350 may be a wired broadband interface module such as LAN or WAN. The communication interface module 350 may also be, e.g., a radio interface module, such as a WLAN, Bluetooth, GSM/GPRS, CDMA, WCDMA, or LTE (Long Term Evolution) radio module. The communication interface module 350 may be integrated into the apparatus 300 or into an adapter, card or the like that may be inserted into a suitable slot or port of the apparatus 300. The communication interface module 350 may support one radio interface technology or a plurality of technologies. FIG. 3 shows one communication interface module 350, but the apparatus 300 may comprise a plurality of communication interface modules 350.

The processor 310 may be, e.g., a central processing unit (CPU), a microprocessor, a digital signal processor (DSP), a graphics processing unit, or the like. FIG. 3 shows one processor 310, but the apparatus 300 may comprise a plurality of processors.

The memory 320 may be for example a non-volatile or a volatile memory, such as a read-only memory (ROM), a programmable read-only memory (PROM), erasable programmable read-only memory (EPROM), a random-access memory (RAM), a flash memory, a data disk, an optical storage, a magnetic storage, a smart card, or the like. The apparatus 300 may comprise a plurality of memories. The memory 320 may be constructed as a part of the apparatus 300 or it may be inserted into a slot, port, or the like of the apparatus 300 by a user. The memory 320 may serve the sole purpose of storing data, or it may be constructed as a part of an apparatus serving other purposes, such as processing data.

The user interface controller 340 may comprise circuitry for receiving input from a user of the apparatus 300, e.g., via a keyboard, graphical user interface shown on the display of the apparatus 300, speech recognition circuitry, or an accessory device, such as a headset, and for providing output to the user via, e.g., a graphical user interface or a loudspeaker.

A skilled person appreciates that in addition to the elements shown in FIG. 3, the apparatus 300 may comprise other elements, such as microphones, displays, as well as additional circuitry such as input/output (I/O) circuitry, memory chips, application-specific integrated circuits (ASIC), processing circuitry for specific purposes such as source coding/decoding circuitry, channel coding/decoding circuitry, ciphering/deciphering circuitry, and the like. Additionally, the apparatus 300 may comprise a disposable or rechargeable battery (not shown) for powering the apparatus 300 when external power if external power supply is not available.

FIG. 4 shows a schematic diagram of a report designer view 400 according to an example embodiment of the present disclosure. Current providers of assessment reports either provide fixed reports, allow users to select which pages to include and/or allow editing of page order, but no provider gives the user all the possible elements of the report as independent elements that the user can include in the report exactly the way that best works for the user.

In an embodiment, an element menu 410 is provided in the report designer view 400. The element menu 410 may comprise a drag-and-drop menu (take an element from the menu 410 and drop it in the middle part 420). In such a way, the user may build the report content by himself. The user has at its disposal all the independent elements, in the element menu 410, that he may drag-and-drop to the right place in the report view 420.

Additionally to using the drag-and-drop method, other methods of selecting the element and its location exist, like pointing with a mouse, double click of the mouse and element order lists may be used.

The user can design a report view 420 by positioning the elements to the report view 420. First, the user may position the elements one after each other from top to bottom to the view 420. Furthermore, the elements may be aligned horizontally in the view 420. The view 420 may comprise columns that contain their own elements. Second, the user may position the elements to pre-defined areas 421-423. The pre-defined areas 421-423 may be fixed in position but the elements may be freely moved, from one position to another, by the user in the report view 420. Third, the user may position the elements freely at any place on the report view 420. The areas 421-423 are not fixed in position but may be freely selected, and after that adjusted, by the user in the report view 420. The elements can later be removed from the report view 420 and the order of the elements can be edited at any time. Furthermore, the elements may be selected and positioned in the report view 420 by using drag-and-drop method, for example.

In an embodiment, a language version for the report information may be selected by the user from a language menu 430. The user can create different language versions of the report and enter the same data in multiple languages.

In an embodiment, an image library (templates/images) may be provided. All the images the user may want to use are saved in the image library available under the elements/fields 410 or the image function 470. Such library allows an uploaded image to be used in multiple places 421-423 and views 420. Furthermore, the library allows the uploaded image to be used in multiple report templates. Furthermore, the library allows the uploaded image to be used by any service system 170 block of FIG. 2. The system maintains information on each image which reports it is linked to. In an embodiment, the library allows maintaining different language versions of each image to support producing assessment reports in multiple languages. The user may give access rights to other users based on nonhierarchical dependencies.

In an embodiment, external elements are provided to enable linking to external applications that provide information based on algorithms either in a report designer server or an external server. These could be results from other assessment instruments, database tables or any database system, like CRM—system or SAP, for example.

In an embodiment, the elements may be static or dynamic. The static elements have fixed content defined by the user, and remain the same in every report (excluding the different language versions). The dynamic elements collect information from (internal or external) databases based on the report related data, like the responses given by the respondent/user, respondent or user related data, date, country, age, among others.

In an embodiment, a preview action 440 is provided. The system allows the user at any time to preview the content of the report using sample data. The preview can be done on the browser or using pdf format, for example.

In an embodiment, the report view 420 may comprise sections. The user defines the content of each section separately. Depending on the amount of data in a section, the system prints the report on one or more pages. The user can also define a page break within a section. The report can contain only one section or any number of sections. The sections can have a name and the order of the sections can be edited at any time. The sections can also be copied.

In an embodiment, the image library also allows updating the used image in all places easily. Maintenance of the same style in all reports (as you do not have different versions of the same image in different report templates) is also improved. The service system may show, for each image, which reports the image is linked to.

In an embodiment, the user can allow other users to have access and use the reports created and/or owned by the user. The other users can be anywhere from the system and there does not have to be any user level structure to define the usage rights. The usage rights can allow the other users to only use the report, edit the report or clone the report (in which case an independent copy of the report is created).

In an embodiment, the reports may be designed for providing information of one respondent and/or several respondents. Multiple person reports allow the user to design the content of the report in a way that best compares the individuals against each other.

In an embodiment, the reports may be designed to contain information from different (internal or external to the system) assessment instruments. The content can be mixed in any way the user prefers or the different instruments can be kept separate in the report.

Reports may also be designed to compare assessment information of the same person using the same assessment instrument. These reports support the analysis of how the person has been changing in time, for example.

In an embodiment, the user can also design reports with dynamic content. User can define any selected element 410 in the report view 420 to automatically monitor the system database and, if new information is saved in the database, to reproduce the report and to automatically send it to desired recipients.

In an embodiment, a text editor 450 is provided. The user can pre-define which font, font size, font colour and other text editor settings he wants to use in his report templates. The pre-defined settings do not need to apply to the whole report view 420. The user can, for example, highlight certain parts of the report to emphasize their importance.

The user can also pre-define templates for his reports. These templates can be viewed using a template action 460. The templates enable including the general layout of the reports, the colours/fonts used in the report, the logo and copyright statements, for example. Separate templates can be designed for different types of pages, like cover and content page, for different types of reports, and for different users, for example.

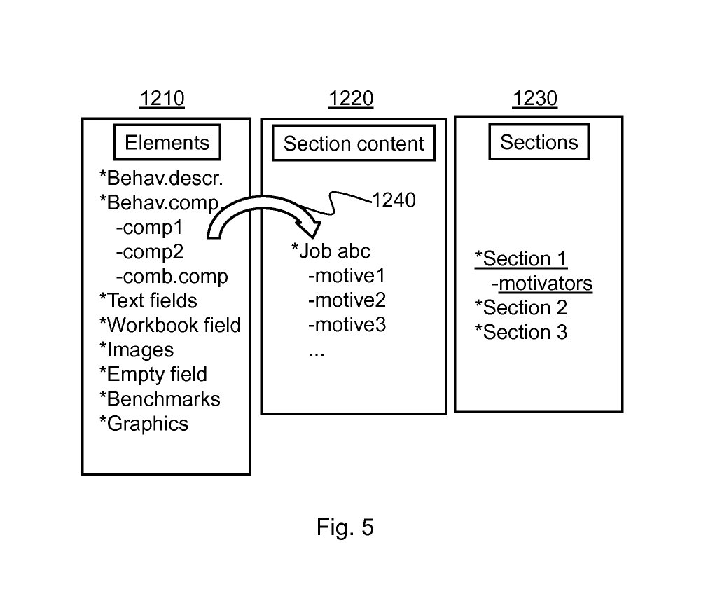

In an embodiment, the assessment report 420 may consist of at least any of the following elements described in FIG. 5.

FIG. 5 shows a schematic diagram of a report elements view according to an example embodiment of the present disclosure. Frame 1220 shows content of a section in a report, corresponding to a report view 420 of FIG. 4, for example. Frame 1210 shows report elements the user has available to include in the report format. The elements 1210 may be selected using the element 410 of FIG. 4. The elements 1210 may be dynamic in nature when the actual content (when the assessment report is produced) depends on the current state of assessment data in the dynamic database, or it can be static with the user pre-defining the content of the data. Frame 1230 shows the sections already created for the report format. The user may add new section, edit, re-order and delete existing ones at any time. Arrow 1240 shows the drag-and-drop method the user may use to place report elements in certain section. The elements may be placed to any section, at any order, and as many times as desired. Also other methods but drag-and-drop may be used for selecting and positioning the report elements.

In an embodiment, the system may allow the user to pilot the report format with dummy data. Furthermore, the report format can be defined for any particular language or set of languages.

The elements 1210 may be owned by the system when they are available to all users, or owned by a user when they are accessible only to the user and every user that has been given access rights to them.

In an embodiment, behavioural descriptor elements are provided. These elements are related to a behavioural style of the respondent. Such elements may be dynamic in nature, and are based on the responses given by the respondent producing different content to the actual printed report. The content is stored and imported from a text/graphics/number database that can be internal in the system or part of an external system (that the system communicates with).

In an embodiment, behavioural competence elements are provided. These elements relate to the behavioural competences of the individual. The competences may be classified in sub-categories, like sales, time management and decision-making, for example. Such elements may be dynamic in nature, calculating the level of competence for each individual or importing a description of the level of competence, based on the responses given by the respondent.

Each user may create new behavioural competences and define the usage rights and ideal score for them.

The user may define if all the selected behavioural competences are included in the actual report or if the system automatically selects a pre-defined number of competences that this person gets best or lowest score with.

In an embodiment, the user may create combinations of the behavioural competences, which makes it easier for the user to select the same set in different reports. It is also possible to allow other users access to templates owned by the user. The user may also give each competence an ideal value that is then compared against each person in the report. The comparison of the values can be presented in graphical and numerical formats, for example. The user may define if all the selected behavioural competences of the combinations of the competences are included in the actual report or if the system automatically selects a pre-defined number of competences that this person gets biggest or smallest gap between the person score and the ideal value.

In an embodiment, text fields may be regarded as static elements. User defines the content of each text field. Typical applications of such elements could be instructions, content of the report, background information and reading guide of the report, for example. The text field elements may utilize a text editor 450 as described in FIG. 4 that allows the user to format the text or parts of it. The text editor can include font size, font type, font colour, alignment, superscript, subscript, underline, italic etc.

In an embodiment, a workbook field element may be provided. The workbook fields may be designed to provide the reader of the report space for writing down own comments/notes/analyses. The size of the field can be defined by number of rows. The rows can be blank, line or spotted line. The user can define if each line has bullet points, numbers or nothing in front of it.

In an embodiment, an image field element is provided for the report view. The user can upload images to the report. The images can be of any normal image format and size. The user can define the place and size of the image in the report and the images may be aligned on the page, if desired.

In an embodiment, benchmark fields are provided. The benchmark fields may be dynamic fields that compare the person(s) in the report to any group of individuals. The benchmarks may be created by the system administrator or by any user. The user can define which other users have access to a benchmark. User benchmarks can be pre-defined or defined only for the purpose of this report.

The benchmarks may be static or dynamic. A static benchmark contains those people that were included in the benchmark at the time the benchmark was created or updated. A dynamic benchmark updates the data based on criteria set for the benchmark.

In an embodiment, an empty field element is provided. The empty fields may be used to leave a part of the report content empty, providing the user with more options to design the report content. The user can define the size of the empty field.

In an embodiment, graphics element may be provided. The graphics elements may be designed to present results of multiple persons in different graphical formats, for example.

In an embodiment, an earlier created report template may, at any time, be edited. Such editing may comprise adding new elements, removing elements, editing elements, and re-ordering elements, for example. After editing, not only the new assessment data but also the earlier assessment data may be reproduced using the edited report template.

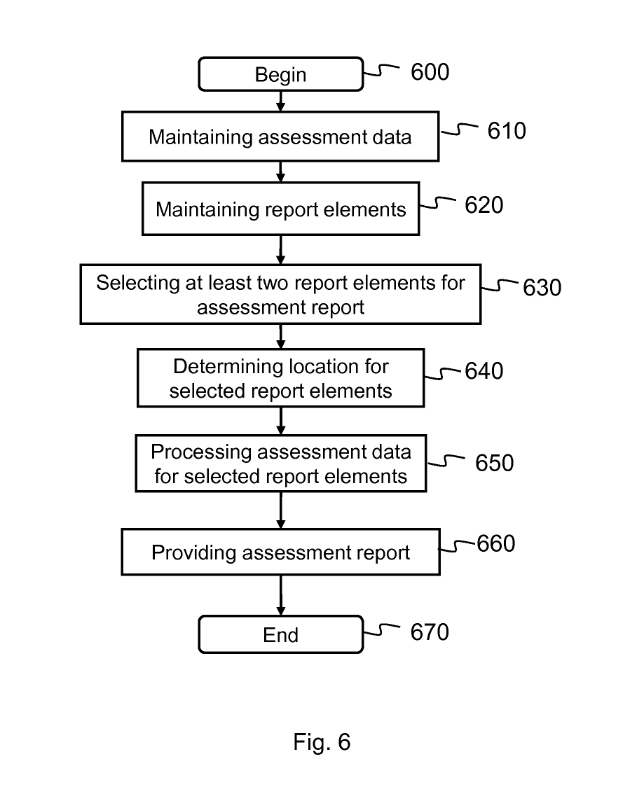

FIG. 6 shows a flow chart of exemplary method steps for providing a dynamic assessment report designer according to an example embodiment of the present disclosure. The method steps may be performed in parallel and the operations may occur in other order. In addition, more steps or fewer steps may be carried out. The method begins at step 600. In step 610, assessment data from a plurality of assessment tools is maintained. In step 620, report elements are maintained for a report template. At least one report element is selected for an assessment report in step 630. In step 640, a location for the selected report elements is determined in the report template. In step 650, the assessment data is processed for the selected report elements. The assessment report is provided using the report template and the processed assessment data in step 660. In step 670, the method ends.

The foregoing description has provided by way of non-limiting examples of particular implementations and embodiments a full and informative description of the best mode presently contemplated by the inventors for carrying out the present disclosure. It is however clear to a person skilled in the art that the invention is not restricted to details of the embodiments presented above, but that it can be implemented in other embodiments using equivalent means or in different combinations of embodiments without deviating from the characteristics of the invention.

Furthermore, some of the features of the above-disclosed embodiments of this present disclosure may be used to advantage without the corresponding use of other features. As such, the foregoing description shall be considered as merely illustrative of the principles of the present disclosure, and not in limitation thereof. Hence, the scope of the invention is only restricted by the appended patent claims.

1. A method comprising:
maintaining, in a database, assessment data from a plurality of assessment tools;
maintaining report elements for a report template;
selecting, by a user, at least one report element for the report template;
determining a location for the selected report element in the report template;
processing the assessment data for the selected report elements; and
providing the assessment report using the report template and the processed assessment data.

2. The method of claim 1, wherein the report elements being static elements comprising static data collected from the database or defined by the user.

3. The method of claim 1, wherein the report elements being dynamic elements comprising dynamic data collected from the database based on the assessment data.

4. The method of claim 1, wherein the assessment data comprising at least one of the following:
data collected for a particular assessment report; and
data collected for a plurality of assessment reports.

5. The method of claim 2, wherein the static data comprising at least one of the following:
responses by a user;
user data; and
user defined data.

6. The method of claim 5, wherein the user data comprising at least one of the following:
country information;
organization information;
brand information;
project information;
application information; and
time information.

7. The method of claim 5, wherein the user defined data comprising at least one of the following:
heading information;
instructions information;
table of content;
background information;
workbook information; and
image information.

8. The method of claim 1, wherein the assessment data comprising at least one of the following:
responses by a respondent;
responses by at least one user;
respondent data; and
user data.

9. The method of claim 8, wherein the responses by the respondent comprising at least one of the following:
data collected from a particular respondent; and
data collected from a plurality of respondents.

10. The method of claim 1, further comprising:
storing a plurality of users, assigned with at least one nonhierarchical dependency, for defining a dynamic user structure.

11. The method of claim 10, further comprising:
storing at least one user, from the plurality of users, as an owner of the report template.

12. The method of claim 11, further comprising:
defining, by the owner, user rights for the report template for other users, the user rights comprising at least one of the following:
access rights to the report template;
edit rights to the report template; and
clone rights to the report template for creating an independent copy of the report template.

13. The method of claim 11, wherein the stored owner allowing users with user specific rights for the report template.

14. The method of claim 1, further comprising:
determining a target for the assessment report from at least one of the following:
a single person;
multiple persons;
a single organization; and
multiple organizations;
selecting a pre-defined report template based on the determined target; and
providing the assessment report using, at least partly, the pre-defined report template and the processed assessment data.

15. The method of claim 1, further comprising:
defining the report elements, the report elements comprising at least one of the following:
a behavioral competence;
a competence template;
a text field;
a workbook field;
an image field;
a benchmark field;
an empty field; and
graphics information.

16. The method of claim 1, wherein the database comprises at least one of a global database and a personal database.

17. The method of claim 16, wherein the global database is accessible to registered users of a service system and the personal database is accessible to users having access rights based on nonhierarchical dependencies.

18. The method of claim 1, further comprising
processing the assessment data for the selected report elements by at least one of the following server apparatuses;
a service system server comprising the database;
an external server; and
a user apparatus.

19. A server apparatus comprising:
a communication unit configured to provide access to a user apparatus;
a processor;
a memory including computer program code;
the memory and the computer program code configured to, with the processor, cause the server apparatus to:
maintain, in a database, assessment data from a plurality of assessment tools;
maintain report elements for a report template;
select, by a user, at least one report element for the report template;
determine a location for the selected report element in the report template;
process the assessment data for the selected report elements; and
provide the assessment report using the report template and the processed assessment data.

20. A computer program embodied on a computer readable medium comprising computer executable program code which, when executed by at least one processor of an apparatus, causes the apparatus to:
maintain, in a database, assessment data from a plurality of assessment tools;
maintain report elements for a report template;
select, by a user, at least one report element for the report template;
determine a location for the selected report element in the report template;
process the assessment data for the selected report elements; and
provide the assessment report using the report template and the processed assessment data.
